(19) United States
(12) Patent Application Publication
(10) Pub. No.: US 2011/0021678 A1
(43) Pub. Date: Jan. 27, 2011

(54) POLYCARBONATE RESIN COMPOSITION, MOLDED POLYCARBONATE RESIN, AND PROCESS FOR PRODUCING THE SAME

(75) Inventors: Toshio Isozaki, Chiba (JP); Kouji Satou, Chiba (JP); Takayoshi Tanaka, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Idemitsu Kosan Co., LTD., Tokyo (JP)

(21) Appl. No.: 12/742,310

(22) PCT Filed: Oct. 24, 2008
(86) PCT No.: PCT/JP2008/069339

§ 371 Date: Oct. 11, 2010

(30) Foreign Application Priority Data
Nov. 13, 2007 (JP) 2007-294731

(51) Int. Cl. C08K 5/56; B29C 45/00

(52) U.S. Cl. 524/174; 264/328.16

(57) ABSTRACT

Disclosed are a polycarbonate resin composition characterized by containing, with respect to 100 parts by mass of a composition formed of (A) 90 to 99 parts by mass of an aromatic polycarbonate resin and (B) 1 part by mass or more and less than 10 parts by mass of a glass filler having a refractive index smaller or larger than that of the aromatic polycarbonate resin by 0.002 or less, (C) 0.01 to 3.0 parts by mass of glossy particles, (D) 0.01 to 3.0 parts by mass of a silicone compound having a reactive functional group, and (E) 0.03 to 1.0 part by mass of an organic alkali metal salt compound and/or an organic alkaline earth metal salt compound, and a polycarbonate resin molded article obtained by molding the composition. The composition may be blended with (F) 0.0001 to 1 part by mass of a colorant as required. Provided are a polycarbonate resin composition having the following characteristics, a polycarbonate resin molded article obtained by molding the resin composition, and a method of producing the polycarbonate resin molded article: the resin composition contains a specific amount of a glass filler with respect to a PC resin composition, no difference in lightness is observed between the left and right of a weld line, and the resin composition is excellent in strength and flame retardancy.

### TECHNICAL FIELD

The present invention relates to a polycarbonate resin composition, a polycarbonate resin molded article using the composition, and a method of producing the molded article, and more specifically, to a polycarbonate resin composition containing a glass filler, which is excellent in, for example, galactic appearance (appearance fully glittering like the night sky studded with stars) and metallic appearance, a polycarbonate resin molded article obtained by molding the resin composition, and a method of producing the molded article.

### BACKGROUND ART

Polycarbonate resin molded articles have been widely used as, for example, industrial transparent materials in the fields of electricity and electronics, machinery, automobiles, and the like or optical materials for lenses, optical disks, and the like because each of the articles is excellent in transparency and mechanical strength. When an additionally high mechanical strength is needed, a glass filler or the like is added to each of the articles to strengthen the article.

Glass fibers each constituted of glass generally called an E glass have been used as the glass filler. However, the refractive index of the E glass at a sodium D line (nD, hereinafter simply referred to as “refractive index”) is somewhat small, specifically, about 1.555, though, the refractive index of a polycarbonate resin is 1.580 to 1.590. Accordingly, when the glass filler is added to a polycarbonate resin composition in an amount needed for an increase in mechanical strength of the composition, the following problem arises: the resultant E glass-reinforced polycarbonate resin composition cannot obtain transparency owing to a difference in refractive index between the filler and the polycarbonate resin. As a result, even when glossy particles are added to the resin, only the glossy particles near the surface of a molded article are seen, so a metallic appearance and a galactic appearance are hardly obtained.

To solve such problems, investigation has been conducted on, for example, a reduction in refractive index of a polycarbonate resin by the improvement of the resin or an increase in refractive index of a glass filler by the improvement of the composition of the glass filler.

For example, (1) a composition containing a polycarbonate resin composition using a product of a reaction between a hydroxyaralkyl alcohol and lactone as a terminating agent and a glass filler having a refractive index smaller or larger than that of the polycarbonate resin composition by 0.01 or less (see Patent Document 1), (2) a composition formed of a polycarbonate resin, a glass filler having a refractive index smaller or larger than that of the polycarbonate resin by 0.015 or less, and polycaprolactone (see Patent Document 2), (3) a glass composition obtained by incorporating, for example, ZrO₂, TiO₂, BaO, and ZnO into a glass filler composition at a specific ratio so that the refractive index of the composition is close to that of a polycarbonate resin (see Patent Document 3) have been proposed.

However, the polycarbonate resin composition in the case of the above proposal (1) is not practical because of the following reasons: when the glass filler is added in an amount needed for an increase in mechanical strength of the composition, the difference in refractive index at such level is not small enough for the addition to exert its effect, and the glass filler is too expensive to be used as a raw material for the production of the polycarbonate resin composition.

The polycarbonate resin composition in the above proposal (2) involves the following problem: reductions in heat resistance and mechanical properties of the composition are inevitable owing to the presence of polycaprolactone, though, the composition can maintain its transparency even when the glass filler has a refractive index smaller or larger than that of the polycarbonate resin by 0.015 or less.

Unless the content of each of, for example, ZrO₂, TiO₂, BaO, and ZnO in the glass composition in the above proposal (3) is appropriately adjusted, the glass filler composition will devitrify. As a result, even when the glass filler composition has a refractive index equal to that of the polycarbonate resin, a polycarbonate resin composition containing the glass filler composition may be unable to obtain transparency. In addition, the significance of the use of a glass filler-reinforced polycarbonate resin composition for the purpose of a weight reduction wanes because the specific gravity of the glass filler itself increases. In addition, there is no description of a weld line and reduction of orientation of glossy particles in the case of the above proposals (1), (2), and (3).

In addition, when the polycarbonate resin composition contains glossy particles in its components, the molding of the resin composition results in a weld line at a portion where the melts of the resin composition merge with each other to weld, with the result that a difference in lightness arises between the left and right of the weld line.

The phenomenon will be described with reference to FIG. 1. As shown in FIG. 1(1), in the case where the resin composition is free of any glass filler, when the melts of the resin composition merge with each other at the central portion to produce a weld line, the glossy particles added to the resin composition for obtaining a metallic appearance or galactic appearance are each brought into a state of being protruded (oriented) without being fallen near the weld line. The reflection of light by the glossy particles is disturbed by the phenomenon, with the result that a resin molded article molded out of the resin composition seems to be dark near the weld line.

Various measures to prevent the phenomenon have been proposed because the emergence of the phenomenon reduces the value of the resin molded article.

For example, (4) particles of shapes having an average particle diameter of 10 to 300 μm and each having an aspect ratio of 1/8 to 1 (see Patent Document 4) and (5) metal fine particles each having a quadrangular shape with a notch at one of its corners (see Patent Document 5) have been proposed as the glossy particles. Those proposals describe that the shape of each of those glossy particles themselves has a preventing effect on the formation of a weld line and a reducing effect on the orientation of the glossy particles.

However, none of the proposals (4) and (5) has description concerning the addition of a glass filler. Moreover, none of the proposals describes flame retardancy, and the number of fields where the particles can be used will be limited unless flame retardancy is imparted to the resin composition.

Although (6) a glass filler-reinforced polycarbonate resin composition having a metallic appearance (see Patent Document 6) has also been proposed, the proposal has no description concerning the reduction of the orientation of glossy particles in a weld line. Moreover, the proposal does not describe flame retardancy, and the number of fields where the resin composition can be used will be limited unless flame retardancy is imparted to the resin composition.

Patent Document 1: JP H7-118514 A

Patent Document 2: JP H9-165506 A

Patent Document 3: JP H5-155638 A

Patent Document 4: JP H6-99594 B

Patent Document 5: JP H7-53768 A

Patent Document 6: JP H6-212068 A

### DISCLOSURE OF THE INVENTION

### Problems to be Solved by the Invention

In view of such circumstances, an object of the present invention is to provide a polycarbonate resin composition having the following characteristics, a polycarbonate resin molded article obtained by molding the resin composition, and a method of producing the resin molded article: the resin composition contains a limited, specific amount of a glass filler, so no difference in lightness is observed between the left and right of a weld line, and the resin composition can obtain a good metallic appearance or galactic appearance, is excellent in strength and heat resistance, and is provided with high flame retardancy.

### Means for Solving the Problems

The inventors of the present invention have made extensive studies with a view to achieving the object. As a result, the inventors have found that the object can be achieved by a flame-retardant polycarbonate resin composition having the following characteristics and a polycarbonate resin molded article obtained by molding the resin composition: the resin composition contains an aromatic polycarbonate resin and a specific amount of glossy particles, the amount in which a glass filler having a refractive index smaller or larger than that of the resin by 0.002 or less is blended is a specific amount with respect to the resin, the resin composition further contains a silicone compound having a reactive functional group, an organic alkali metal salt compound and/or an organic alkaline earthmetal salt compound, and, as required, a colorant at a predetermined ratio, and the resin composition has an excellent flame-retardant grade. The present invention has been completed on the basis of such finding.

More specifically, the present invention provides the followings:

(1) a polycarbonate resin composition comprising, with respect to 100 parts by mass of a composition formed of (A) more than 90 parts by mass and 99 parts by mass or less of an aromatic polycarbonate resin and (B) 1 part by mass or more and less than 10 parts by mass of a glass filler having a refractive index smaller or larger than a refractive index of the aromatic polycarbonate resin by 0.002 or less, (C) 0.01 to 3.0 parts by mass of glossy particles, (D) 0.01 to 3.0 parts by mass of a silicone compound having a reactive functional group, and (E) 0.03 to 1.0 part by mass of an organic alkali metal salt compound and/or an organic alkaline earth metal salt compound;

(2) the polycarbonate resin composition according to the above item (1), wherein the glass filler as the component (B) comprises glass fibers;

(3) the polycarbonate resin composition according to the above item (1) or (2), wherein the refractive index of the glass filler as the component (B) is 1.583 to 1.587;

(4) the polycarbonate resin composition according to any one of the above items (1) to (3), wherein the glossy particles as the component (C) comprise one or two or more kinds selected from the group consisting of mica, metal particles, metal sulfide particles, particles each having a surface coated with a metal or a metal oxide, and glass flakes each having a surface coated with a metal or a metal oxide;

(5) the polycarbonate resin composition according to anyone of the above items (1) to (4), further comprising (F) 0.0001 to 1 part by mass of a colorant with respect to 100 parts by mass of the composition formed of the component (A) and the component (B);

(6) a polycarbonate resin molded article obtained by molding the polycarbonate resin composition according to any one of the above items (1) to (5);

(7) the polycarbonate resin molded article according to the above item 8, wherein the polycarbonate resin molded article is obtained by injection molding at a mold temperature of 120° C. or higher;

(8) the polycarbonate resin molded article according to the above item (6) or (7), wherein the polycarbonate resin molded article has a flame retardancy determined by a flame retardancy evaluation method in conformance with UL94 of 1.5 mmV-0;

(9) the polycarbonate resin molded article according to any one of the above items (6) to (8), wherein the glass filler in a pellet or molded article of the polycarbonate resin composition has an average length of 300 μm or more; and

(10) a method of producing a polycarbonate resin molded article comprising subjecting the polycarbonate resin composition according to any one of the above items (1) to (5) to injection molding at a mold temperature of 120° C. or higher to produce the molded article.

### Effects by the Invention

According to the present invention described in any one of claims 1 to 4, there can be provided a polycarbonate resin composition excellent in transparency, strength, and heat resistance, and provided with high flame retardancy. Further, the content of the glass filler falls within a specific range, so a polycarbonate resin molded article having the following characteristic can be obtained by molding the resin composition: even when the polycarbonate resin molded article has a weld line, no difference in lightness is observed between the left and right of the weld line.

According to the present invention described in claim 5, there can be further provided a polycarbonate resin composition having an arbitrary color tone.

According to the present invention described in any one of claims 6 to 9, there can be provided a polycarbonate resin molded article which is obtained by molding the resin composition having the above excellent characteristics, and which has an excellent galactic appearance or metallic appearance.

According to the present invention described in claim 10, there can be provided a method of producing a polycarbonate resin molded article which is obtained by molding the resin composition having the above excellent characteristics, and which has an excellent galactic appearance or metallic appearance.

### BRIEF DESCRIPTION OF THE DRAWINGS

FIG. 1 is views for illustrating the states of glossy particles on the left and right of a weld line changed by the presence or absence of a glass filler.

### BEST MODE FOR CARRYING OUT THE INVENTION

The polycarbonate resin (hereinafter, abbreviated as “PC resin”) composition of the present invention contains, with respect to 100 parts by mass of a composition formed of (A) more than 90 parts by mass and 99 parts by mass or less of an aromatic polycarbonate resin and (B) 1 part by mass or more and less than 10 parts by mass of a glass filler having a refractive index smaller or larger than a refractive index of the aromatic polycarbonate resin by 0.002 or less, (C) 0.01 to 3.0 parts by mass of glossy particles, (D) 0.01 to 3.0 parts by mass of a silicone compound having a reactive functional group, and (E) 0.03 to 1.0 part by mass of an organic alkali metal salt compound and/or an organic alkaline earth metal salt compound.

To be specific, in the PC resin composition of the present invention, an aromatic polycarbonate resin produced by a reaction between a dihydric phenol and a carbonate precursor can be used as the aromatic polycarbonate resin as the component (A).

A method of producing the PC resin as the component (A) is not particularly limited, and resins produced by various conventional methods can each be used as the PC resin. For example, a resin produced from a dihydric phenol and a carbonate precursor by a solution method (interfacial polycondensation method) or a melt method (ester exchange method), that is, a resin produced by, for example, an interfacial polycondensation method involving causing the dihydric phenol and phosgene to react with each other in the presence of a terminating agent or an ester exchange method involving causing the dihydric phenol and diphenyl carbonate or the like to react with each other in the presence of a terminating agent can be used.

As the dihydric phenol, various examples are given. In particular, examples thereof include 2,2-bis(4-hydroxyphenyl)propane [bisphenol A], bis(4-hydroxyphenyl)methane, 1,1-bis(4-hydroxyphenyl)ethane, 2,2-bis(4-hydroxy-3,5-dimethylphenyl)propane, 4,4′-dihydroxydiphenyl, bis(4-hydroxyphenyl)cycloalkane, bis(4-hydroxyphenyl)oxide, bis(4-hydroxyphenyl)sulfide, bis(4-hydroxyphenyl)sulfone, bis(4-hydroxyphenyl)sulfoxide, and bis(4-hydroxyphenyl)ketone. In addition, hydroquinone, resorcin, and catechol or the like can be also exemplified. One kind of those dihydric phenols may be used alone, or two or more kinds thereof may be used in combination. Of those, bis(hydroxyphenyl)alkanes are preferred, and bisphenol A is particularly preferred.

On the other hand, as the carbonate precursor, a carbonyl halide, carbonyl ester, or a haloformate, and the like are given. Specifically, phosgene, dihaloformate of a dihydricphenol, diphenyl carbonate, dimethyl carbonate, and diethyl carbonate are given.

It should be noted that the PC resin may have a branched structure. As a branching agent, 1,1,1-tris(4-hydroxyphenyl)ethane, α,α′, α″-tris(4-hydroxyphenyl)-1,3,5-triisopropylbenzene, phloroglycine, trimellitic acid, isatinbis(o-cresol), and the like are exemplified.

In the present invention, a viscosity average molecular weight (Mv) of PC resin used as (A) component is generally 10,000 to 50,000, preferably 13,000 to 35,000, and more preferably 15,000 to 20,000.

The viscosity average molecular weight (Mv) is calculated by the following equation, after a limiting viscosity [η] is obtained by determining a viscosity of methylene chloride solution at 20° C. by using a Ubbelohde type viscometer.

[η]=1.23×10⁻⁵Mv^{0.83}

A molecular terminal group in the aromatic PC resin as the component (A) is not particularly limited, and a monovalent, phenol-derived group as a conventionally known terminating agent may be used; a monovalent, phenol-derived group having an alkyl group having 10 to 35 carbon atoms is preferred. When the molecular terminal is a phenol-derived group having an alkyl group having 10 or more carbon atoms, a PC resin composition to be obtained has good flowability. In addition, when the molecular terminal is a phenol-derived group having an alkyl group having 35 or less carbon atoms, the PC resin composition to be obtained has good heat resistance and good impact resistance.

Examples of the monovalent phenol having an alkyl group having 10 to 35 carbon atoms include decyl phenol, undecyl phenol, dodecyl phenol, tridecyl phenol, tetradecyl phenol, pentadecyl phenol, hexadecyl phenol, heptadecyl phenol, octadecyl phenol, nonadecyl phenol, icosyl phenol, docosyl phenol, tetracosyl phenol, hexacosyl phenol, octacosyl phenol, triacontyl phenol, dotriacontyl phenol, and pentatriacontyl phenol.

The alkyl group may be present at any one of the o-, m-, and p-positions of each of those alkyl phenols with respect to the hydroxyl group; the alkyl group is preferably present at the p-position. In addition, the alkyl group may be a linear group, a branched group, or a mixture of them.

At least one substituent of each of the alkyl phenols has only to be the alkyl group having 10 to 35 carbon atoms, and the other four substituents are not particularly limited; each of the other four substituents may be an alkyl group having 1 to 9 carbon atoms, an aryl group having 6 to 20 carbon atoms, or a halogen atom, or each of the alkyl phenols may be unsubstituted except for the hydroxyl group and the alkyl group having 10 to 35 carbon atoms.

Only one of the terminals of the PC resin may be sealed with a monovalent phenol having the alkyl group having 10 to 35 carbon atoms, or each of both the terminals may be sealed with the phenol. In addition, terminals each denatured with the phenol account for preferably 20% or more, or more preferably 50% or more of all terminals from the viewpoint of an improvement in flowability of the PC resin composition to be obtained.

That is, the other terminals may each be sealed with a hydroxyl group terminal or any one of the other terminating agents in the following description.

Herein, examples of the other terminating agents include phenol, p-cresol, p-tert-butylphenol, p-tert-octylphenol, p-cumylphenol, p-nonylphenol, p-tert-amylphenol, bromophenol, tribromophenol, and pentabromophenol, which are commonly used in the production of the PC resin. Of those, a halogen-free compound is preferred in view of environmental issues.

In the PC resin composition of the present invention, the aromatic PC resin as the component (A) can appropriately contain, in addition to the PC resin, a copolymer such as a polyester-polycarbonate resin obtained by polymerizing polycarbonate in the presence of an ester precursor such as a bifunctional carboxylic acid such as terephthalic acid or an ester-forming derivative of the acid, or any other polycarbonate resin to such an extent that the object of the present invention is not impaired.

The PC resin composition of the present invention must satisfy the following requirements: a difference between the refractive index of the glass filler to be used as the component (B) and the refractive index of the aromatic PC resin as the component (A) is 0.002 or less, and more than 90 parts by mass and 99 parts by mass or less of the PC resin, and 1 part by mass or more and less than 10 parts by mass of the glass filler are incorporated into 100 parts by weight of a composition of the PC resin and the glass filler.

When the difference in refractive index between the glass filler and the PC resin exceeds 0.002, a molded article obtained by using the PC resin composition has insufficient transparency. The difference in refractive index is preferably 0.001 or less; the refractive index of the glass filler and the refractive index of the aromatic PC resin to be used as the component (A) are particularly preferably equal to each other. A glass filler having a refractive index of 1.583 to 1.587 is preferably used as such glass filler.

As glass of which such glass filler described above is constituted, a glass I or glass II having the following composition are exemplified.

It is preferred that the glass I contains 50 to 60% by mass of silicone oxide (SiO₂), 10 to 15% by mass of aluminum oxide (Al₂O₃), 15 to 25% by mass of calcium oxide (CaO), 2 to 10% by mass of titanium oxide (TiO₂), 2 to 8% by mass of diboron trioxide (B₂O₃). 0 to 5% by mass of magnesium oxide (MgO), 0 to 5% by mass of zinc oxide (ZnO), 0 to 5% by mass of barium oxide (BaO), 0 to 5% by mass of zirconium oxide (ZrO₂), 0 to 2% by mass of lithium oxide (Li₂O), 0 to 2% by mass of sodium oxide (Na₂O), and 0 to 2% by mass of potassium oxide (K₂O), and have a total content of the lithium oxide (Li₂O) the sodium oxide (Na₂O), and the potassium oxide (K₂O) of 0 to 2% by mass.

On the other hand, it is preferred that the glass II contains 50 to 60% by mass of silicone oxide (SiO₂), 10 to 15% by mass of aluminum oxide (Al₂O₃), 15 to 25% by mass of calcium oxide (CaO), 2 to 5% by mass of titanium oxide (TiO₂), 0 to 5% by mass of magnesium oxide (MgO), 0 to 5% by mass of zinc oxide (ZnO), 0 to 5% by mass of barium oxide (BaO), 2 to 5% by mass of zirconium oxide (ZrO₂), 0 to 2% by mass of lithium oxide (Li₂O), 0 to 2% by mass of sodium oxide (Na₂O), and 0 to 2% by mass of potassium oxide (K₂O), be substantially free of diboron trioxide (B₂O₃), and have a total content of the lithium oxide (Li₂O), the sodium oxide (Na₂O) and the potassium oxide (K₂O) of 0 to 2% by mass.

The content of SiO₂ in each of the glass I and glass II is preferably 50 to 60% by mass from the viewpoints of the strength of the glass filler and solubility at the time of the production of each of the glasses. The content of Al₂O₃ is preferably 10 to 15% by mass from the viewpoints of the chemical durability of each of the glasses such as water resistance and solubility at the time of the production of each of the glasses. The content of CaO is preferably 15 to 25% by mass from the viewpoints of solubility at the time of the production of each of the glasses and the suppression of the crystallization of each of the glasses.

The glass I can contain 2 to 8% by mass of B₂O₃ like the E glass. In this case, the content of TiO₂ is preferably 2 to 10% by mass from the viewpoints of, for example, an improving effect on the refractive index of the glass and the suppression of the devitrification of the glass.

In addition, it is preferred that the glass II be substantially free of B₂O₃ like ECR glass composition, which is excellent in acid resistance and alkali resistance. In this case, the content of TiO₂ is preferably 2 to 5% by mass from the viewpoint of the adjustment of the refractive index of the glass. In addition, the content of ZrO₂ is preferably 2 to 5% by mass from the viewpoints of an increase in refractive index of the glass, an improvement in chemical durability of the glass, and solubility at the time of the production of the glass.

In each of the glasses I and II, MgO is an arbitrary component, and can be incorporated at a content of about 0 to 5% by mass from the viewpoints of an improvement in durability of each of the glasses such as a tensile strength and solubility at the time of the production of each of the glasses. In addition, ZnO and BaO are also arbitrary components, and each of them can be incorporated at a content of about 0 to 5% by mass from the viewpoints of an increase in refractive index of each of the glasses and the suppression of the devitrification of each of the glasses.

In the glass I, ZrO₂ is an arbitrary component, and can be incorporated at a content of about 0 to 5% by mass from the viewpoints of an increase in refractive index of the glass and solubility at the time of the production of the glass.

In each of the glass I and glass II, Li₂O, Na₂O, and K₂O as alkali components are arbitrary components, and each of them can be incorporated at a content of about 0 to 2% by mass. In addition, the total content of the alkali components is preferably 0 to 2% by mass. When the total content is 2% by mass or less, a reduction in water resistance of each of the glasses can be suppressed.

As described above, each of the glass I and glass II contains a small amount of alkali components, so a reduction in molecular weight of the PC resin composition due to the decomposition of the aromatic PC resin as the component (A) can be suppressed, and reductions in physical properties of an article molded out of the PC resin composition can be prevented.

Each of the glass I and glass II may contain, in addition to the glass components, for example, an oxide containing an element such as lanthanum (La), yttrium (Y), gadolinium (Gd), bismuth (Bi), antimony (Sb), tantalum (Ta), niobium (Nb), or tungsten (W) as a component for increasing the refractive index of the glass to such an extent that the spinning property, water resistance, and the like of the glass are not adversely affected. In addition, each of the glasses may contain an oxide containing an element such as cobalt (Co), copper (Cu), or neodymium (Nd) as a component for discoloring the yellow color of the glass.

In addition, the content of Fe₂O₃ as an impurity on an oxide basis in the glass raw materials to be used in the production of each of the glass I and glass II is preferably less than 0.01% by mass with respect to the entirety of the glass in order that the coloring of the glass may be suppressed.

The glass filler as the component (B) in the PC resin composition of the present invention can be obtained by: appropriately choosing a glass having a refractive index smaller or larger than that of the aromatic polycarbonate resin as the component (A) to be used by 0.002 or less from the glass I and glass II each having the above-mentioned glass composition; and forming the chosen glass into a desired shape.

Although the morphology of the glass filler is not particularly limited, the glass filler in a pellet or molded article of the composition desirably has an average fiber length of 300 μm or more in order that a difference in lightness between the left and right of a weld line may be reduced to such an extent as to be unobservable. From such viewpoint, glass fibers are suitable.

The glass fibers can be obtained by employing a conventionally known spinning method for glass long fibers. For example, glass can be turned into fibers by employing any one of the various methods such as: a direct melt (DM) method involving continuously turning glass raw materials into glass in a melting furnace, introducing the resultant glass into a forehearth, and spinning the glass by attaching a bushing to the bottom of the forehearth; and a remelting method involving processing molten glass into a marble-, cullet-, or rod-like shape, remelting the resultant, and spinning the resultant.

Although the diameter of each of the glass fibers is not particularly limited, fibers each having a diameter of about 3 to 25 μm are preferably used in ordinary cases. When the diameter is 3 μm or more, irregular reflection is suppressed, whereby a reduction in transparency of the molded article can be prevented. In addition, when the diameter is 25 μm or less, the molded article to be obtained has a good strength.

As described above, the glass fibers in the pellet or molded article desirably have an average length of 300 μm or more, or preferably 350 μm or more. When the average length of the glass fibers is less than 300 μm, the following tendency is observed: a reducing effect on the difference in lightness between the left and right of the weld line is hardly obtained.

It should be noted that the average length can be measured by incinerating part of the pellet or molded article with an electric furnace in the air at 600° C. for 2 hours and observing the combustion residue with a microscope or the like.

The surface of the glass filler is preferably treated with a coupling agent in order that the glass filler may show an increased affinity for the aromatic polycarbonate resin as the component (A), adhesiveness between the glass filler and the resin may be improved, and reductions in transparency and strength of the molded article due to the formation of voids in the glass filler may be suppressed.

A silane-based coupling agent, a borane-based coupling agent, an aluminate-based coupling agent, a titanate-based coupling agent, or the like can be used as the coupling agent. The silane-based coupling agent is particularly preferably used because adhesiveness between the aromatic PC resin and the glass filler can be improved.

Specific examples of the silane-based coupling agent include triethoxy silane, vinyltris(β-methoxyethoxy)silane, γ-methacryloxypropyl trimethoxy silane, γ-glycidoxypropyl trimethoxysilane, β-(1,1-epoxycylohexyl)ethyltrimethoxy silane, β-(3,4-epoxycyclohexyl)ethyl trimethoxy silane, N-β-(aminoethyl)-γ-aminopropyl trimethoxy silane, N-β-(aminoethyl)-γ-aminopropylmethyl dimethoxyl silane, γ-aminopropyl triethoxy silane, N-phenyl-γ-aminopropyl trimethoxy silane, γ-mercaptopropyl trimethoxy silane, γ-chloropropyl trimethoxy silane, γ-aminopropyl trimethoxy silane, γ-aminopropyl tris(2-methoxy-ethoxy)silane, N-methyl-γ-aminopropyl trimethoxy silane, N-vinylbenzyl-γ-aminopropyl triethoxy silane, triaminopropyl trimethoxy silane, 3-ureidepropyl trimethoxy silane, 3-(4,5-dihydroimidazolyl)propyl triethoxy silane, hexamethyl disilazane, N,O-(bistrimethylsilyl)amide, and N,N-bis(trimethylsilyl)urea. Of those, preferred are amino silanes and epoxy silanes such as γ-aminopropyl trimethoxy silane, N-β-(aminoethyl)-γ-aminopropyl trimethoxy silane, γ-glycidoxypropyl trimethoxy silane, and β-(3,4-epoxycyclohexyl)ethyl trimethoxy silane.

The surface of the glass filler can be treated with such coupling agent by an ordinary known method without any particular limitation. The surface treatment can be performed by an appropriate method depending on the shape of the glass filler; examples of the method include a sizing treatment method involving applying a solution or suspension of the above coupling agent in an organic solvent as the so-called sizing agent to the glass filler, a dry mixing method involving the use of a Henschel mixer, a super mixer, a Redige mixer, a V-type blender, or the like, a spray method, an integral blend method, and a dry concentrate method. The surface treatment is desirably performed by the sizing treatment method, the dry mixing method, or the spray method.

The PC resin composition of the present invention must contain the aromatic polycarbonate resin as the component (A) in an amount of more than 90 parts by mass and 99 parts by mass or less and the glass filler as the component (B) in an amount of 1 part by mass or more and less than 10 parts by mass on the basis of the total amount of the components (A) and (B), i.e., 100 parts by mass. Preferably, component (A) is in an amount of 92 to 98 parts by mass and component (B) is in an amount of 2 to 8 parts by mass.

A content of the component (B) of less than 1% by mass is not preferable because an improving effect on the rigidity of the composition is not sufficiently exerted. A content of the component (B) of 10 parts by mass or more is not preferable either because a difference in lightness is observed between the left and right of the weld line.

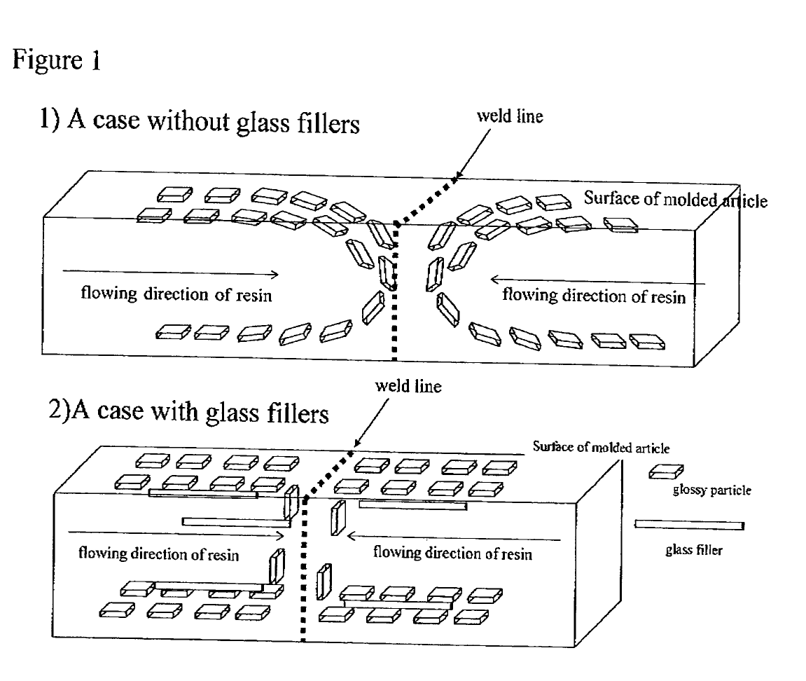

The reason why setting the content of the glass filler within a specific range precludes the emergence of a difference in lightness between the left and right of the weld line of the molded article in the present invention will be described with reference to FIG. 1.

FIG. 1(2) shows the states of glossy particles when a resin composition contains a glass filler like the present invention.

That is, in the case of the present invention, when the left and right flows of the resin composition merge with each other at the center, even if a weld line is produced, the glass filler flows parallel to the direction in which the resin composition flows. In addition, the parallel flow acts to inhibit the orientation of the glossy particles, and the glossy particles also flow parallel to the glass filler, whereby the rise-up of the glossy particles is nearly eliminated on the left and right of the weld line. As a result, in the present invention, even when the left and right of the weld line are observed, the reflection of light by the glossy particles becomes substantially uniform, whereby no difference in lightness is observed.

Examples of the glossy particles as the component (C) in the PC resin composition of the present invention include mica, metal particles, metal sulfide particles, particles each having a surface coated with a metal or a metal oxide, and glass flakes each having a surface coated with a metal or a metal oxide.

Specific examples of the metal particles include metal powders each made of, for example, aluminum, gold, silver, copper, nickel, titanium, or stainless steel. Specific examples of the particles each having a surface coated with a metal or a metal oxide include metal oxide coating mica-based particles such as mica titanium coated with titanium oxide and mica coated with bismuth trichloride. Specific examples of the metal sulfide particles include metal sulfide powders each made of, for example, nickel sulfide, cobalt sulfide, or manganese sulfide. A metal used in each of the glass flakes each having a surface coated with a metal or a metal oxide is, for example, gold, silver, platinum, palladium, nickel, copper, chromium, tin, titanium, or silicon.

The glossy particles as the component (C) preferably have a volume average particle diameter of about 10 to 300 μm.

The above glossy particles as the component (C) are blended in an amount of 0.01 to 3.0 parts by mass, or preferably 0.3 to 1.5 part by mass with respect to 100 parts by mass of the composition formed of the components (A) and (B).

The case where the amount of component (C) is less than 0.01 part by mass is not preferable because a galactic appearance and a metallic appearance of the PC resin composition is hardly formed. The case where the amount exceeds 3.0 parts by mass is not preferable either because the amount in which the glossy particles themselves emerge on the surface increases to impair the appearance, and the flame retardancy of the PC resin composition tend to reduce.

The silicone compound having a reactive functional group as the component (D) and (E) an organic alkali metal salt compound and/or an organic alkaline earth metal salt compound are added to the PC resin composition of the present invention for the purpose of, for example, an additional improvement in flame retardancy of the composition.

Examples of the silicone compound having a reactive functional group as the component (D) (which may hereinafter be referred to as “reactive functional group-containing silicone compound”) include polyorganosiloxane polymers and/or copolymers each having a basic structure represented by a general formula (1).

R¹ₐR²_{b}SiO_{(4-a-b)/2} (1)

In the general formula (1), R¹ represents a reactive functional group. Examples of the functional group include an alkoxy group, an aryloxy group, a polyoxyalkylene group, a hydrogen group, a hydroxy group, a carboxy group, a silanol group, an amino group, a marcapto group, an epoxy group, and a vinyl group. Of those, preferred are the alkoxy group, the hydroxy group, the hydrogen group, the epoxy group, and the vinyl group.

R² represents a hydrocarbon group having 1 to 12 carbon atoms. Examples of the hydrocarbon group include a linear or branched alkyl group having 1 to 12 carbon atoms, a cycloalkyl group having 5 to 12 carbon atoms, an aryl group having 6 to 12 carbon atoms, and an aralkyl group having 7 to 12 carbon atoms. Specific examples thereof include a methyl group, an ethyl group, an n-propyl group, an isopropyl group, various butyl groups, various pentyl groups, various hexyl groups, various octyl groups, a cyclopentyl group, a cyclohexyl group, a phenyl group, a tolyl group, a xylyl group, a benzyl group, and a phenetyl group.

a and b represent a number satisfying relationships of 0<a≦3, 0<b≦3, and 0<a+b≦3. When multiple R¹'s are present, the multiple R¹'s may be the same or different from one another. When multiple R²'s are present, the multiple R²'s may be the same or different from one another.

In the present invention, polyorganosiloxane polymers and/or copolymers each having multiple reactive functional groups of the same kind, and polyorganosiloxane polymers and/or copolymers each having multiple reactive functional groups of different kinds can be used in combination.

The polyorganosiloxane polymers and/or copolymers each having the basic structure represented by the general formula (1) each have a ratio of the number of its reactive functional groups (R¹) to the number of its hydrocarbon groups (R²) of typically about 0.1 to 3, or preferably about 0.3 to 2.

Such reactive functional group-containing silicone compound, which is a liquid, powder, or the like, preferably shows good dispersibility in melting and mixing. For example, a liquid compound having a viscosity at room temperature of about 10 to 500,000 mm²/s can be used.

The PC resin composition of the present invention has the following characteristics: even when the reactive functional group-containing silicone compound is a liquid, the compound is uniformly dispersed in the composition, and bleeds at the time of molding or to the surface of the molded article to a small extent.

In the PC resin composition of the present invention, the reactive functional group-containing silicone compound as the component (D) is incorporated in an amount of 0.01 to 3.0 parts by mass with respect to 100 parts by mass of the composition formed of the components (A) and (B).

When the content of the component (D) is less than 0.01 part by mass, a preventing effect on dripping at the time of the combustion of the composition is insufficient. In addition, when the content exceeds 3.0 parts by mass, a screw starts to slide at the time of the kneading of the raw materials for the composition, so the raw materials cannot be successfully fed, and the ability of an apparatus including the screw to produce the composition reduces. The content of the component (D) is preferably 0.1 to 1.5 part by mass, or more preferably 0.5 to 1.0 part by mass from the viewpoints of the prevention of the dripping and productivity. In addition, such reactive functional group-containing silicone compound has a refractive index of preferably 1.45 to 1.65, or more preferably 1.48 to 1.60 in order that the composition may retain its translucency at the time of the addition of the compound.

The organic alkali metal salt compound and/or the organic alkaline earth metal salt compound as the component (E) are/is added to the PC resin composition of the present invention for the purpose of, for example, further improving flame retardancy of the composition.

Various compounds can be given as examples of the organic alkali metal salt compound and/or the organic alkaline earth metal salt compound; an alkali metal salt or alkaline earth metal salt of an organic acid or organic ester having at least one carbon atom is typically used.

Herein, examples of the organic acid and organic acid ester include organic sulfonic acid, organic carboxylic acid, and polystyrene sulfonic acid. On the other hand, examples of the alkali metal include sodium, potassium, lithium, and cesium. Examples of the alkaline earth metal include magnesium, calcium, strontium, and barium. Of those, the salt of sodium, potassium, or cesium is preferably used. In addition, the salt of the organic acid may be substituted by a halogen atom such as fluorine, chlorine, or bromine.

An alkali metal salt compound or alkaline earth metal salt compound of a perfluoroalkanesulfonic acid represented by a general formula (2) is preferably used as an alkali metal salt compound or alkaline earth metal salt compound of an organic sulfonic acid out of the various organic alkali metal salt compounds and organic alkaline earth metal salt compounds:

(C_{c}F_{2c+1}SO₃)_{d}M (2)

where c represents an integer of 1 to 10, M represents an alkali metal such as lithium, sodium, potassium, or cesium, or an alkaline earth metal such as magnesium, calcium, strontium, or barium, and d represents the valence of M.

A compound described in, for example, Japanese Examined Patent Publication No. Sho 47-40445 corresponds to such compound.

In the general formula (2), examples of the perfluoroalkane sulfonic acid include perfluoromethane sulfonate, perfluoroethane sulfonate, perfluoropropane sulfonate, perfluorobutane sulfonate, perfluoromethyl butane sulfonate, perfluorohexane sulfonate, perfluoroheptane sulfonate, and perfluorooctane sulfonate. In particular, potassium salts thereof are preferably used.

In addition, examples thereof include alkyl sulfonate, benzene sulfonate, alkyl benzene sulfonate, diphenyl sulfonate, naphthalene sulfonate, 2,5-dichlorobenzene sulfonate, 2,4,5-trichlorobenzene sulfonate, diphenylsulfone-3-sulfonate, diphenylsulfone-3,3′-disulfonate, naphthalene trisulfonate, fluoro-derivatives thereof, and alkali metal salts or alkaline earth metal salts of organic sulfonic acids such as polystyrene sulfonate.

Subsequently, as the alkali metal salt compounds and/or alkaline earth metal salt compounds of polystyrene sulfonic acid, a sulfonate group-containing aromatic vinyl-based resin represented by a general formula (3) is exemplified:

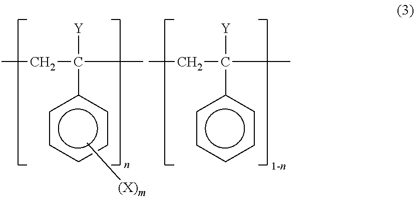

where: X represents a sulfonate group; m represents 1 to 5; Y represents a hydrogen atom or a hydrocarbon group having 1 to 10 carbon atoms; and n represents a mole fraction and satisfies the relationship of 0<n≦1.

Herein, the sulfonate group is an alkali metal salt and/or an alkaline earth metal salt of sulfonic acid. In addition, as the metal, sodium, potassium, lithium, rubidium, cesium, berylium, magnesium, calcium, strontium, and barium are exemplified.

It should be noted that Y represents a hydrogen atom or a hydrocarbon group having 1 to 10 carbon atoms, or preferably represents a hydrogen atom or a methyl group. m represents 1 to 5, and n satisfies the relationship of 0<n≦1. That is, each aromatic ring may be substituted with the sultanate group (X) at each of all the five positions, may be substituted with the group at each of part of the positions, or may be unsubstituted except for one position.

In order that the PC resin composition of the present invention may obtain flame retardancy, the ratio at which the aromatic rings are substituted with the sulfonate groups is determined in consideration of, for example, the content of the sulfonate group-containing aromatic vinyl-based resin, and is not particularly limited; the substitution ratio of the resin to be generally used is 10 to 100%.

It should be noted that the sulfonate group-containing aromatic vinyl-based resin in the category of the alkali metal salt and/or alkaline earth metal salt of polystyrene sulfonic acid is not limited to a sulfonate group-containing aromatic vinyl-based resin represented by the general formula (3), and may be a copolymer of a styrene-based monomer and any other copolymerizable monomer.

Herein, a method of producing the sulfonate group-containing aromatic vinyl-based resin is, for example, (a) a method involving polymerizing the aromatic vinyl-based monomers each having a sulfonic group and the like or copolymerizing any such monomer and any other copolymerizable monomer, or (b) a method involving sulfonating an aromatic vinyl-based polymer, a copolymer of an aromatic vinyl-based monomer and any other copolymerizable monomer, or a mixture of these polymers and neutralizing the resultant with an alkali metal and/or an alkaline earth metal.

For example, in the case of the method (b), a sulfonated polystyrene is produced by: adding a mixed liquid of concentrated sulfuric acid and acetic anhydride to a solution of a polystyrene resin in 1,2-dichloroethane; and heating the mixture to cause them to react with each other for several hours. Subsequently, the resultant is neutralized with the same number of moles of potassium hydroxide or sodium hydroxide as that of sulfonate groups, whereby a potassium salt or sodium salt of polystyrene sulfonic acid can be obtained.

A weight average molecular weight of the sulfonate group-containing aromatic vinyl-based resin is 1,000 to 300,000, preferably about 2,000 to 200,000. It should be noted that the weight average molecular weight can be measured by gel permeation chromatography (GPC) method.

Examples of the organic carboxylic acid include perfluorocarboxylic acid, perfluoromethane carboxylic acid, perfluoroethane carboxylic acid, perfluoropropane carboxylic acid, perfluorobutane carboxylic acid, perfluoromethyl butane carboxylic acid, perfluorohexane carboxylic acid, perfluoroheptane carboxylic acid, and perfluorooctane carboxylic acid. Alkali metal salts or alkaline earth metal salts of those organic carboxylic acids are used. The alkali metal salts and alkaline earth metal salts are the same as the above-mentioned metal salts.

Of the organic alkali metal salts and organic alkali earth salts, sulfonic acid alkali metal salts, sulfonic acid alkaline earth metal salts, polystyrene sulfonic acid alkali metal salts, and polystyrene sulfonic acid alkaline earth metal salts are preferred.

One kind of the organic alkali metal salt compound and/or organic alkali earth salt compound may be used or two or more kinds of them may be used in combination.

The organic alkali metal salt compound and/or the organic alkaline earth metal salt compound as the component (E) must be incorporated into the PC resin composition of the present invention at a content of 0.03 to 1.0 part by mass with respect to 100 parts by mass of the composition formed of the components (A) and (B).

When the content of the component (E) is less than 0.03 part by mass, the composition exerts additional flame retardancy to an insufficient extent. In addition, when the content exceeds 1.0 part by mass, it becomes difficult for the composition to maintain transparency. The content of the component (E) is preferably 0.05 to 0.4 part by mass, or more preferably 0.1 to 0.3 part by mass from the viewpoints of the exertion of the flame retardancy and the maintenance of the transparency.

In the present invention, (F) a colorant may be included in the case where a colored molded article is desired.

The above colorant as the component (F) is desirably free of opacifying property, and examples of the colorant include a methine-based dye, a pyrazolone-based dye, a perinone-based dye, an azo-based dye, a quinophthalone-based dye, and an anthraquinone-based dye.

The above colorant as the component (F) is blended in an amount of, preferably 0.0001 to 1.0 part by mass, or more preferably 0.3 to 1.0 part by mass with respect to 100 parts by mass of the composition formed of the aromatic PC resin as the component (A) and the glass filler as the component (B). When the amount is less than 0.0001 part by mass, it is difficult for the PC resin composition to obtain a desired color tone. When the amount exceeds 1.0 part by mass, the opacifying property of the colorant is strengthened, so it is difficult for the PC resin composition to obtain a metallic appearance.

In addition to the components (A), (B), (C), (D), (E), and (F), an antioxidant, a UV absorber, a release agent, an antistatic agent, a fluorescent bleach, a silane coupling agent (when the surface of the glass filler is treated by the dry mixing method), and the like can be appropriately incorporated into the PC resin composition of the present invention as required to such an extent that the object of the present invention is not impaired.

As an antioxidant, phenol-based antioxidants and phosphorous-based antioxidants are preferably used.

Examples of the phenol-based antioxidants include triethylene glycol-bis[3-(3-tert-butyl-5-methyl-4-hydroxyphenyl)propionate],1,6-hexanediol-bis[3-(3,5-di-tert-butyl-4-hydroxyphenyl)propionate], pentaerythritol-tetrakis[3-(3,5-di-tent-butyl-4-hydroxyphenyl)propionate], octadecyl-3-(3,5-di-tert-butyl-4-hydroxyphenyl)propionate, 1,3,5-trimethyl-2,4,6-tris(3,5-di-text-butyl-4-hydroxybenzyl)benzene, N,N-hexemethylenebis(3,5-di-tert-butyl-4-hydroxy-hydrocinnamide), 3,5-di-tent-butyl-4-hydroxy-benzylphophonate diethyl ester, tris(3,5-di-text-butyl-4-hydroxybenzyl)isocyanurate, and 3,9-bis{1,1-dimethyl-2-[-(β-(3-tert-butyl-4-hydroxy-5-methylphenyl)propionyloxy]ethyl}-2,4,8,10-tetraoxaspiro(5,5)undecane

Examples of the phosphorous-based antioxidants include triphenylphosphite, trisnonylphenylphosphite, tris(2,4-di-tert-butylphenyl)phosphite, tridecylphosphite, trioctylphopshite, trioctadecylphosphite, didecylmonophenyl phosphite, dioctylmonophenyl phosphite, diisopropylmonophenyl phosphite, momobutyldiphenyl phosphite, monodecyldiphenyl phosphite, monooctyldiphenyl phosphite, bis(2,6-di-text-butyl-4-methylphenyl)pentaerythritol diphosphite, 2,2-methylenebis(4,6-di-tert-butylphenyl)octyl phosphite, bis(nonylphenyl)pentaery thritol diphosphite, bis(2,4-di-tert-butylphenyl)pentaerythritol diphosphite, and distearyl pentaerythritol diphosphite.

One kind of those antioxidants may be used alone, or two or more kinds of them may be used in combination. Such antioxidant is typically added in an amount of about 0.05 to 1.0 part by mass with respect to 100 parts by mass of the composition formed of the aromatic PC resin as the component (A) and the glass filler as the component (B).

As the UV absorber, benzotriazole-based UV absorber, triazine-based UV absorber, benzooxazine-based UV absorber, and benzophenone-based UV absorber may be used.

Examples of the benzotriazole-based UV absorber include 2-(2′-hydroxy-5′-methylphenyl)benzotriazole, 2-(2′-hydroxy-3′-(3,4,5,6-tetrahydrophthal imide methyl)-5′-methyphenyl)benzotriazole, 2-(2′-hydroxy-3′,5′-di-tert-butylphenyl)benzotriazole, 2-(2′-hydroxy-5′-tert-octylphenyl)benzotriazole, 2-(3′-tert-butyl-5′-methyl-2′-hydroxyphenyl)-5-chlorobenzotriazole, 2,2′-methylenebis(4-(1,1,3,3-tetramethylbutyl)-6-(2H-benzotriazole-2-yl)phenol), 2-(2′-hydroxy-3′,5′-bis(α, α-dimethylbenzyl)phenyl)-2H-benzotriazole, 2-(3′,5′-di-tert-amyl-2′-hydroxyphenyl)benzotriazole, and 5-trifluoromethyl-2-(2-hydroxy-3-(4-methoxy-α-cumyl)-5-tert-butylphenyl)-2H-benzotriazole. Of those, 2-(2′-hydroxy-5′-text-octylphenyl)benzotriazole is preferred.

As the triazine-based UV absorber, TINUVIN 400 (product name) (manufactured by Ciba Specialty Chemicals Inc.) which is a hydroxyphenyl triazine-based UV absorber is preferred.

Examples of the benzooxazine-based UV absorber include 2-methyl-3,1-benzooxazine-4-one, 2-butyl-3,1-benzooxazine-4-one, 2-phenyl-3,1-benzooxazine-4-one, 2-(1- or 2-naphthyl)-3,1-benzooxazine-4-one, 2-(4-biphenyl)-3,1-benzooxazine-4-one, 2,2′-bis(3,1-benzooxazine-4-one), 2,2′-p-phenylenebis(3,1-benzooxazine-4-one), 2,2′-m-phenylenebis(3,1-benzooxazine-4-one), 2,2′-(4,4′-diphenylene)bis(3,1-benzooxazine-4-one), 2,2′-(2,6- or 1,5-naphthalene)bis(3,1-benzooxazine-4-one), and 1,3,5-tris(3,1-benzooxazine-4-one-2-yl)benzene. Of those, 2,2′-p-phenylenebis(3,1-benzooxazine-4-one) is preferred.

Examples of the benzophenone-based UV absorber include 2-hydroxy-4-methoxy benzophenone, 2-hydroxy-4-n-octoxybenzophenone, 2-hydroxy-4-methoxy-2′-carboxybenzophenone, 2,4-dihydroxybenzophenone, and 2,2-dihydroxy-4-methoxy benzophenone. Of those, 2-hydroxy-4-n-octoxybenzophenone is preferred.

One kind of those UV absorbers may be used alone, or two or more kinds of them may be used in combination. Such UV absorber is typically added in an amount of about 0.05 to 2.0 part by mass with respect to 100 parts by mass of the composition formed of the component (A) and the component (B).

A higher fatty acid ester of a monohydric or polyhydric alcohol can be used as the release agent. Such higher fatty acid ester is preferably a partial or complete ester of a monohydric or polyhydric alcohol having 1 to 20 carbon atoms and a saturated fatty acid having 10 to 30 carbon atoms. Examples of the partial ester or the complete ester of a monohydric or polyhydric alcohol and the saturated fatty acid include monoglyceride stearate, monosorbitate stearate, monoglyceride behenate, pentaerythritol monostearate, pentaerythritol tetrastearate, propyleneglycol monostearate, stearyl stearate, palmitylpalmitate, butyl stearate, methyl laurate, isopropyl palmitate, and 2-ethylhexyl stearate. Of those, monoglyceride stearate and pentaerythritol tetrastearate are preferably used.

One kind of those release agents may be used alone, or two or more kinds of them may be used in combination. Such release agent is typically added in an amount of about 0.1 to 5.0 parts by mass with respect to 100 parts by mass of the composition formed of the component (A) and the component (B).

As the antistatic agent, for example, a monoglyceride of the fatty acid having 14 to 30 carbon atoms, and more specifically, monoglyceride stearate, monoglyceride palmitate, or a polyamide polyether block copolymer may be used.

As the fluorescent bleach, for example, stilbene-based, benzoimidazole-based, naphthalimide-based, rhodamine-based, coumarin-based, and oxazine-based compounds are exemplified. More specifically, commercially-available products such as UVITEX (product name, manufactured by Ciba Specialty Chemicals Inc.), OB-1 (product name, manufactured by Eastman Chemical Company.), TBO (product name, manufactured by SUMITOMO SEIKA CHEMICALS CO., LTD.), Kcoll (product name, manufactured by NIPPON SODA CO., LTD.), Kayalight (product name, manufactured by NIPPON KAYAKU CO., LTD.), and Leucophor EGM (product name, manufactured by Clariant Japan) may be used.

It should be noted that the compounds exemplified above can be used as a silane coupling agent.

A method of preparing the PC resin composition of the present invention is not particularly limited, and a conventionally known method can be adopted. To be specific, the composition can be prepared by: blending the aromatic PC resin as the component (A), the glass filler as the component (B), the glossy particles as the component (C), the reactive functional group-containing silicone compound as the component (D), the organic alkali metal salt compound and/or the organic alkaline earth metal salt compound as the component (E), and, as required, the colorant as the component (F), and additionally, the various arbitrary components to be used as required at a predetermined ratio; and kneading the mixture.

The blending and the kneading are performed by a method using, for example, a ribbon blender and a drum tumbler for a preparing mixing, a Henschel mixer, a Banbury mixer, a single-screw extruder, a twin-screw extruder, a multi-screw extruder, and a cokneader. Heating temperature in melt-kneading is appropriately selected generally from a range of about 240 to 300° C.

It should be noted that any component to be incorporated other than the aromatic PC resin can be melted and kneaded with part of the aromatic PC resin in advance before being added: the component can be added as a master batch.

The PC resin composition of the present invention thus prepared has a flame retardancy determined by evaluation for flame retardancy in conformance with UL94 of 1. 5 mmV-0, so the composition has excellent flame retardancy. It should be noted that a flame retardancy evaluation test is described later.

Subsequently, a PC resin molded article of the present invention is described.

The PC resin molded article of the present invention is obtained by molding the above-mentioned PC resin composition of the present invention. Upon molding, the thickness of the PC resin composition is preferably about 0.3 to 10 mm, and is appropriately selected from the above range depending on an application of the molded article.

A method of producing the PC resin molded article of the present invention is not particularly limited, and any one of the various conventionally known molding methods such as an injection molding method, an injection compression molding method, an extrusion molding method, a blow molding method, a press molding method, a vacuum molding method, and a foam molding method can be employed; injection molding at a mold temperature of 120° C. or higher is preferable, and injection molding at a mold temperature of 120° C. to 140° C. is more preferable. In this case, a resin temperature in the injection molding is typically about 290 to 300° C., or preferably 260 to 280° C.

Injection molding at a mold temperature of 120° C. or higher, or preferably 120° C. to 140° C. provides, for example, the following merit: the glass filler sinks, so the molded article can obtain a good appearance. The mold temperature is more preferably 125° C. or higher and 140° C. or lower, or still more preferably 130° C. to 140° C.

The PC resin composition of the present invention as a molding raw material is preferably pelletized by the melting kneading method before being used.

It should be noted that gas injection molding for the prevention of sink marks in the appearance of the molded article or for a reduction in weight of the molded article can be adopted as an injection molding method.

Even when a weld line is formed in the PC resin molded article of the present invention thus obtained, no difference in lightness is observed between the left and right of the weld line, so the entire surface of the molded article can obtain a good metallic appearance or galactic appearance.

It should be noted that a method of measuring the difference in lightness between the left and right of the weld line will be described later.

In addition, the present invention provides a method of producing a PC resin molded article characterized by including subjecting the above-mentioned PC resin composition of the present invention to injection molding at a mold temperature of 120° C. or higher, or preferably 120 to 140° C. to produce a molded article having a thickness of preferably 0.3 to 10 mm.

The PC resin composition of the present invention contains glass filler and glossy particles having a refractive index equal or close to that of the aromatic PC resin, is excellent in, for example, transparency, mechanical strength, impact resistance, and heat resistance, and is provided with high flame retardancy because it contains a reactive functional group-containing silicone compound, and an organic alkali metal salt compound, and/or an organic alkali earth metal salt compound. The PC resin molded article of the present invention obtained by using the composition is excellent in, for example, transparency, flame retardancy, mechanical strength, impact resistance, and heat resistance in addition to a metallic appearance and a galactic appearance.

The PC resin molded article of the present invention is preferably used for the following items, for example:
(1) various parts of televisions, radio cassettes, video cameras, video tape recorders, audio players, DVD players, air conditioners, portable phones, displays, computers, resistors, electric calculators, printers, and facsimiles, and electrical/electronic device parts such as outside plates and housing materials;
(2) parts for precision apparatuses such as cases and covers of precision apparatuses such as PDA's, cameras, slide projectors, clocks, gages, display apparatuses;
(3) parts for automobiles such as automobile interior materials, exterior products, and automobile body parts including instrument panels, upper garnishes, radiator grills, speaker grills, wheel covers, sunroofs, head lump reflector's, door visors, spoilers, rear windows, and side windows; and
(4) parts for furniture such as chairs, tables, desks, blinds, lighting covers, and interior instruments.

### Examples

Hereinafter, the present invention is described in more detail by way of examples and comparative examples, but the present invention is not limited thereto.

It should be noted that a test piece was molded out of a PC resin composition pellet obtained in each of the following examples and comparative examples as described below, and was evaluated for various characteristics.

### (1) Mechanical Characteristics

A pellet was subjected to injection molding with a 100-t injection molding machine [manufactured by TOSHIBA MACHINE CO., LTD., device name “IS100E”] at a mold temperature of 130° C. and a resin temperature of 280° C., whereby respective test pieces each having a predetermined form were produced.

The deflection temperature of each test piece were measured in conformance with ASTM D648, and the specific gravity of the test piece were each measured in conformance with ASTM 792.

### (2) Flame Retardancy

A pellet was subjected to injection molding with a 45-t injection molding machine [manufactured by TOSHIBA MACHINE CO., LTD., device name “IS45PV”] at a mold temperature of 130° C. and a resin temperature of 280° C., whereby a test piece measuring 127×12.7×1.5 mm was produced. The flame retardancy of the test piece was measured in conformance with Underwriters Laboratories Subject 94 (UL94)

### (3) Optical Characteristics

A pellet was subjected to injection molding with a 100-t injection molding machine [manufactured by Sumitomo Heavy Industries, Ltd., device name “SG100M-HP”] by using a mold having a two-point gate at a mold temperature of 130° C., whereby a test piece having a weld line measuring 80×80×2 mm was produced. The test piece thus obtained was irradiated with daylight obliquely at 45° so that whether a difference in lightness was observed between glossy particles on the left and right of the weld line might be determined.

### (4) Measurement of Lengths of Glass Fibers in Pellet

Several grams of a pellet were weighed in an SiO₂/Al₂O₃ crucible, and were baked with a muffle furnace FP-21 manufactured by YAMATO SCIENTIFIC CO., LTD. in the air at 600° C. for 2 hours. After that, part of the combustion residue was sandwiched between slide glasses, and the lengths of fibers in the residue were observed with a universal projector V-243 manufactured by Nikon Corporation. The lengths of 200 fibers were measured in every measurement, and the average of the measured values was determined. The foregoing operation was performed for one sample three times, and the average of the measured values was defined as an average fiber length.

The kinds of the respective components used in the production of each PC resin composition pellet are shown below.
(1) PC; bisphenol A polycarbonate having a viscosity average molecular weight of 19,000 [manufactured by Idemitsu Kosan Co., Ltd., trade name “TARFLON FN1900A”, refractive index 1.585]
(2) Refractive index-improved GF1; glass fibers each formed of a chopped strand having a refractive index of 1.585 and measuring φ13 μm×3 mm [manufactured by ASAHI FIBER GLASS Co., Ltd., glass composition: SiO₂ 57.5% by mass, Al₂O₃ 12.0% by mass, CaO 21.0% by mass, TiO₂ 5.0% by mass, MgO 2.5% by mass, ZnO 1.5% by mass, Na₂O+K₂O+Li₂O=0.5% by mass]
(3) GF1; glass fibers each formed of a chopped strand which is made of an E glass having a refractive index of 1.555 and measuring φ13 μm×3 mm [manufactured by ASAHI FIBER GLASS Co., Ltd., trade name “03MA409C”, glass composition: SiO₂ 55.4% by mass, Al₂O₃14.1% by mass, CaO 23.2% by mass, B₂O₃ 6.0% by mass, MgO 0.4% by mass, Na₂O+K₂+O Li₂O=0.7% by mass, Fe₂O₃ 0.2% by mass, F₂ 0.6% by mass]
(4) GF2; glass fibers each formed of a chopped strand which is made of an ECR glass having a refractive index of 1.579 and measuring φ13 μm×3 mm [manufactured by ASAHI FIBER GLASS Co., Ltd., glass composition: SiO₂ 58.0% by mass, Al₂O₃ 11.4% by mass, CaO 22.0% by mass, TiO₂ 2.2% by mass, MgO 2.7% by mass, ZnO 2.7% by mass, Na₂O+K₂O+Li₂O=0.8% by mass, Fe₂O₃ 0.2% by mass]
(5) Stabilizer 1; an antioxidant. octadecyl 3-(3,5-di-tert-butyl-4-hydroxyphenyl)propionate [manufactured by Ciba Specialty Chemicals Inc., trade name “Irganox 1076”]
(6) Stabilizer 2; an antioxidant. tris(2,4-di-tert-butylphenyl)phosphite [manufactured by Ciba Specialty Chemicals Inc., trade name “Irgafos 168”]
(7) Release agent; pentaerythritol tetrastearate [manufactured by RIKEN VITAMIN CO., LTD., trade name “EW440A”]
(8) Frame retardant 1; potassium perfluorobutane sulfonate [manufactured by DAINIPPON INK AND CHEMICALS., trade name “Megafac F114”]
(9) Flame retardant 2; a 30% by mass aqueous solution of sodium polystyrene sulfonate having a weight average molecular weight of 20,000 and a sulfonation ratio of 100% [manufactured by Lion Corporation, trade name “LEOSTAT FRPSS-NA30”]
(10) Flame retardant assistant 1; a reactive silicone compound having a refractive index of 1.51 and having a vinyl group and a methoxy group as functional groups [manufactured by Shin-Etsu Chemical Co., Ltd., trade name “KR-219”]
(11) Flame retardant assistant 2; a reactive silicone compound having a refractive index of 1.49 and having a vinyl group and a methoxy group as functional groups [manufactured by Dow Corning Corporation, trade name “DC3037”]
(12) Flame retardant assistant 3: polytetrafluoroethylene resin [manufactured by ASAHI GLASS CO., LTD., trade name “CD076”]
(13) Glossy particles 1: glass flake coated with titanium oxide [manufactured by Nippon Sheet Glass Co., Ltd., trade name “MC1030RS”]
(14) Glossy particles 2: glass flake coated with titanium oxide and silicone oxide [manufactured by MERCK, trade name “Miraval 5411”]
(15) Glossy particles 3: aluminum foil coated with a coloring material [manufactured by Nihonboshitsu Co., Ltd., trade name “Astroflake”]
(16) Colorant 1; anthraquinone-based orange dye [manufactured by Mitsubishi Chemical Corporation., trade name “Dia Resin Orange HS”]
(17) Colorant 2; anthraquinone-based green dye [manufactured by Sumitomo Chemical Co., Ltd., trade name “Sumiplast green G”]

### Examples 1 to 7 and Comparative Examples 1 to 9

In each of the examples and the comparative examples, the respective components were mixed at a blending ratio shown in Table 1, and the mixture was melted and kneaded with a biaxial extruder [manufactured by TOSHIBA MACHINE CO., LTD., device name “TEM-35B”] at 280° C., whereby a PC resin composition pellet was produced.

A test piece was molded out of each pellet as described above, and its mechanical characteristics, flame retardancy, and optical characteristics were determined. Table 1 shows the results.

TABLE 1

| | | Example | | | | | |
|---|---|---|---|---|---|---|---|
| | | 1 | 2 | 3 | 4 | 5 | 6 |
| PC resin | (A) PC | 98 | 97 | 95 | 92 | 98 | 95 |
| composition | (B) Refractive index- | 2 | 3 | 5 | 8 | 2 | 5 |
| (part by mass) | improved GF1 | | | | | | |
| | (B) GF1 | — | — | — | — | — | — |
| | (B) GF2 | — | — | — | — | — | — |
| | Stabilizer 1 | 0.1 | 0.1 | 0.1 | 0.1 | 0.1 | 0.1 |
| | Stabilizer 2 | 0.1 | 0.1 | 0.1 | 0.1 | 0.1 | 0.1 |
| | Release agent | 0.8 | 0.8 | 0.8 | 0.8 | 0.8 | 0.8 |
| | (E) Flame retardant 1 | 0.15 | 0.15 | 0.1 | 0.1 | — | 0.1 |
| | (E) Flame retardant 2 | — | — | — | — | 0.3 | — |
| | (D) Flame retardant | 0.6 | — | 0.6 | 0.6 | 0.6 | 0.6 |
| | assistant 1 | | | | | | |
| | (D) Flame retardant | — | 1.0 | — | — | — | — |
| | assistant 2 | | | | | | |
| | (D) Flame retardant | — | — | — | — | — | — |
| | assistant 3 | | | | | | |
| | (C) Glossy particles 1 | 0.3 | 0.5 | 1 | 1 | — | — |
| | (C) Glossy particles 2 | — | — | — | — | 0.8 | — |
| | (C) Glossy particles 3 | — | — | — | — | — | 2 |
| | (E) Colorant 1 | 0.1 | 0.1 | 0.1 | 0.1 | 0.1 | 0.1 |
| | (E) Colorant 2 | 0.3 | 0.3 | 0.3 | 0.3 | 0.3 | 0.3 |
| Mechanical | Deflection | 128 | 128 | 131 | 138 | 128 | 131 |
| characteristics | temperature (° C.) | | | | | | |
| | Specific gravity | 1.21 | 1.22 | 1.24 | 1.26 | 1.21 | 1.24 |
| Fiber length | Average fiber length | 350 | 380 | 400 | 400 | 350 | 400 |
| | in pellet (μm) | | | | | | |
| Optical | Difference in lightness | Unobservable | Unobservable | Unobservable | Unobservable | Unobservable | Unobservable |
| characteristics | between left and right | | | | | | |
| | of weld | | | | | | |
| | appearance | Galactic | Galactic | Galactic | Galactic | Galactic | Galactic |
| Flame | UL-94 | V-0 | V-0 | V-0 | V-0 | V-0 | V-0 |
| retardancy | [test piece thickness: | | | | | | |
| | 1.5 mm] | | | | | | |

| | | Example | Comparative Example | | | | |
|---|---|---|---|---|---|---|---|
| | | 7 | 1 | 2 | 3 | 4 | 5 |
| PC resin | (A) PC | 98 | 80 | 85 | 99.5 | 98 | 95 |
| composition | (B) Refractive index- | 2 | 20 | 15 | 0.5 | 2 | — |
| (part by mass) | improved GF1 | | | | | | |
| | (B) GF1 | — | — | — | — | — | 5 |
| | (B) GF2 | | | — | — | — | — |
| | Stabilizer 1 | 0.1 | 0.1 | 0.1 | 0.1 | 0.1 | 0.1 |
| | Stabilizer 2 | 0.1 | 0.1 | 0.1 | 0.1 | 0.1 | 0.1 |
| | Release agent | 0.8 | 0.8 | 0.8 | 0.8 | 0.8 | 0.8 |
| | (E) Flame retardant 1 | 0.1 | 0.1 | 0.1 | 0.1 | 0.15 | 0.15 |
| | (E) Flame retardant 2 | — | — | — | — | — | — |
| | (D) Flame retardant | 0.6 | 0.3 | 0.3 | 0.3 | 0.6 | 0.6 |
| | assistant 1 | | | | | | |
| | (D) Flame retardant | — | — | — | — | — | — |
| | assistant 2 | | | | | | |
| | (D) Flame retardant | — | — | — | — | — | — |
| | assistant 3 | | | | | | |
| | (C) Glossy particles 1 | 0.3 | 2 | 2 | 2 | 5 | 1 |
| | (C) Glossy particles 2 | 0.3 | — | — | — | — | — |
| | (C) Glossy particles 3 | — | — | — | — | — | — |
| | (E) Colorant 1 | 0.1 | 0.1 | 0.1 | 0.1 | 1 | 0.1 |
| | (E) Colorant 2 | 0.3 | 0.3 | 0.3 | 0.3 | 3 | 0.3 |
| Mechanical | Deflection | 128 | 144 | 141 | 126 | 128 | 131 |
| characteristics | temperature (° C.) | | | | | | |
| | Specific gravity | 1.21 | 1.33 | 1.30 | 1.20 | 1.21 | 1.24 |
| Fiber length | Average fiber length | 350 | 400 | 400 | 400 | 350 | 400 |
| | in pellet (μm) | | | | | | |
| Optical | Difference in lightness | Unobservable | Oservable | Oservable | Oservable | Oservable | Unobservable |
| characteristics | between left and right | | | | | | |
| | of weld | | | | | | |
| | Appearance | Galactic | Galactic | Galactic | Galactic | Galactic | Marble |
| Flame | UL-94 | | | | | | |
| retardancy | [test piece thickness: | V-0 | V-0 | V-0 | V-1 | V-0 | V-0 |
| | 1.5 mm] | | | | | | |

| | | Comparative Example | | | |
|---|---|---|---|---|---|
| | | 6 | 7 | 8 | 9 |
| PC resin | (A) PC | 95 | 98 | 98 | 98 |
| composition | (B) Refractive index- | — | 2 | 2 | 2 |
| (part by mass) | improved GF1 | | | | |
| | (B) GF1 | — | — | — | — |
| | (B) GF2 | 5 | — | — | — |
| | Stabilizer 1 | 0.1 | 0.1 | 0.1 | 0.1 |
| | Stabilizer 2 | 0.1 | 0.1 | 0.1 | 0.1 |
| | Release agent | 0.8 | 0.8 | 0.8 | 0.8 |
| | (E) Flame retardant 1 | 0.15 | 0.15 | — | 0.1 |
| | (E) Flame retardant 2 | — | — | — | — |
| | (D) Flame retardant | 0.6 | — | — | — |
| | assistant 1 | | | | |
| | (D) Flame retardant | — | — | — | — |
| | assistant 2 | | | | |
| | (D) Flame retardant | — | 0.3 | — | — |
| | assistant 3 | | | | |
| | (C) Glossy particles 1 | 1 | 0.3 | 0.3 | 0.3 |
| | (C) Glossy particles 2 | — | — | — | — |
| | (C) Glossy particles 3 | — | — | — | — |
| | (E) Colorant 1 | 0.1 | 1 | 0.1 | 0.1 |
| | (E) Colorant 2 | 0.3 | 3 | 0.3 | 0.3 |
| Mechanical | Deflection | 131 | 128 | 128 | 128 |
| characteristics | temperature (° C.) | | | | |
| | Specific gravity | 1.24 | 1.21 | 1.21 | 1.21 |
| Fiber length | Average fiber length | 400 | 350 | 350 | 350 |
| | in pellet (μm) | | | | |
| Optical | Difference in lightness | Unobservable | Unobservable | Unobservable | Unobservable |
| characteristics | between left and right | | | | |
| | of weld | | | | |
| | Appearance | Marble | Marble | Galactic | Galactic |
| Flame | UL-94 | V-0 | V-0 | V-2out | V-0 |
| retardancy | [test piece thickness: | | | | |
| | 1.5 mm] | | | | |

Table 1 shows the following.

Each of the examples shows the following: when a PC resin composition obtained by blending a composition formed of a predetermined amount of an aromatic PC resin and a predetermined amount of a glass filler having a refractive index smaller or larger than that of the PC resin by 0.002 or less with glossy particles, a reactive functional group-containing silicone compound, and an organic alkali metal salt compound, and, furthermore, a colorant is molded, no difference in lightness is observed between the left and right of the weld line of the molded article, and the molded article obtains a good galactic appearance. Further, each of the examples shows that the resin composition can be provided with excellent flame retardancy while maintaining its strength and heat resistance.

Comparative Examples 1 and 2 show the following: even in the case of a resin composition formed of an aromatic PC resin, a glass filler having a refractive index smaller or larger than that of the PC resin by 0.002 or less, an organic alkali metal salt compound, silicone having a reactive functional group, glossy particles, and a colorant, when the amount in which the glass filler is blended exceeds the range specified in the present invention, the resin composition can maintain sufficient flame retardancy, but a difference in lightness is observed between the left and right of the weld line, so the entire surface of the resin composition has a poor galactic appearance.

Comparative Example 3 shows the following: even in the case of a resin composition formed of an aromatic PC resin, a glass filler having a refractive index smaller or larger than that of the PC resin by 0.002 or less, an organic alkali metal salt compound, silicone having a reactive functional group, glossy particles, and a colorant, when the amount in which the glass filler is blended is lower than the range specified in the present invention, the resin composition cannot maintain sufficient flame retardancy, and a difference in lightness is observed between the left and right of the weld line, so the entire surface of the resin composition has a poor galactic appearance.

Comparative Example 4 shows the following: even in the case of a resin composition formed of an aromatic PC resin, a glass filler having a refractive index smaller or larger than that of the PC resin by 0.002 or less, an organic alkali metal salt compound, silicone having a reactive functional group, glossy particles, and a colorant, when the amount in which the glossy particles are blended exceeds the range specified in the present invention, the resin composition can maintain sufficient flame retardancy, but a difference in lightness is observed between the left and right of the weld line, so the entire surface of the resin composition has a poor galactic appearance.

Comparative Examples 5 and 6 show the following: a resin composition formed of an aromatic PC resin, a glass filler formed of an E glass (having a refractive index of 1.555) or ECR glass (having a refractive index of 1.579) having a refractive index smaller or larger than that of the PC resin by more than 0.002, an organic alkali metal salt compound, silicone having a reactive functional group, glossy particles, and a colorant can maintain its strength and flame retardancy, but the surface pattern of the resin composition is marble, and cannot be provided with a galactic appearance.

Comparative Example 7 shows the following: even in the case of a resin composition formed of an aromatic PC resin, a glass filler having a refractive index smaller or larger than that of the PC resin by 0.002 or less, an organic alkali metal salt compound, glossy particles, and a colorant, when a polytetrafluoroethylene resin is used as a flame retardant assistant, the resin composition can maintain its strength and flame retardancy, but the surface pattern of the resin composition is marble, and cannot be provided with a galactic appearance.

Comparative Example 8 shows the following: a resin composition formed of an aromatic PC resin, a glass filler having a refractive index smaller or larger than that of the PC resin by 0.002 or less, glossy particles, and a colorant can maintain its strength and galactic appearance, but cannot be provided with flame retardancy.

Comparative Example 9 shows the following: a resin composition formed of an aromatic PC resin, a glass filler having a refractive index smaller or larger than that of the PC resin by 0.002 or less, an organic alkali metal salt compound, glossy particles, and a colorant can maintain its strength and galactic appearance, but cannot be provided with sufficient flame retardancy again.

### INDUSTRIAL APPLICABILITY

The PC resin composition of the present invention contains a glass filler having a refractive index equal or close to that of its aromatic PC resin, glossy particles, a reactive silicone compound, an organic alkali metal salt compound and/or an organic alkaline earth metal salt compound, and, as required, a colorant. A molded article having the following characteristics can be obtained by molding the PC resin composition as a raw material: even when a weld line is produced in the molded product, no difference in lightness is observed between the left and right of the weld line, and the molded article is excellent in mechanical strength. Further, such resin composition is provided with high flame retardancy, and the PC resin molded article of the present invention obtained by using the composition can suitably find applications in a wide variety of fields.

1. A polycarbonate resin composition comprising, with respect to 100 parts by mass of a composition formed of (A) more than 90 parts by mass and 99 parts by mass or less of an aromatic polycarbonate resin and (B) 1 part by mass or more and less than 10 parts by mass of a glass filler having a refractive index smaller or larger than a refractive index of the aromatic polycarbonate resin by 0.002 or less, (C) 0.01 to 3.0 parts by mass of glossy particles, (D) 0.01 to 3.0 parts by mass of a silicone compound having a reactive functional group, and (E) 0.03 to 1.0 part by mass of an organic alkali metal salt compound and/or an organic alkaline earth metal salt compound.

2. The polycarbonate resin composition according to claim 1, wherein the glass filler as the component (B) comprises glass fibers.

3. The polycarbonate resin composition according to claim 1, wherein the refractive index of the glass filler as the component (B) is 1.583 to 1.587.

4. The polycarbonate resin composition according to claim 1, wherein the glossy particles as the component (C) comprise one or two or more kinds selected from the group consisting of mica, metal particles, metal sulfide particles, particles each having a surface coated with a metal or a metal oxide, and glass flakes each having a surface coated with a metal or a metal oxide.

5. The polycarbonate resin composition according to claim 1, further comprising (F) 0.0001 to 1 part by mass of a colorant with respect to 100 parts by mass of the composition formed of the component (A) and the component (13).

6. A polycarbonate resin molded article obtained by molding the polycarbonate resin composition according to claim 1.

7. The polycarbonate resin molded article according to claim 6, wherein the polycarbonate resin molded article is obtained by injection molding at a mold temperature of 120° C. or higher.

8. The polycarbonate resin molded article according to claim 6, wherein the polycarbonate resin molded article has a flame retardancy of 1.5 mmV-0 determined by a flame retardancy evaluation method in conformance with UL94.

9. The polycarbonate resin molded article according to claim 6, wherein the glass filler in a pellet or molded article of the polycarbonate resin composition has an average length of 300 μm.

10. A method of producing a polycarbonate resin molded article comprising subjecting the polycarbonate resin composition according to claim 1 to injection molding at a mold temperature of 120° C. or higher to produce the molded article.
